(19) United States
(12) Patent Application Publication
(10) Pub. No.: US 2025/0313151 A1
(43) Pub. Date: Oct. 9, 2025

(54) VEHICULAR INTERIOR MIRROR ASSEMBLY WITH DRIVER MONITORING CAMERA AND FRONT CAMERA INTEGRATION

(71) Applicant: Magna Mirrors of America, Inc., Holland, MI (US)

(72) Inventor: Nathan J. Pastoor, Jenison, MI (US)

(21) Appl. No.: 19/097,988

(22) Filed: Apr. 2, 2025

Related U.S. Application Data
(60) Provisional application No. 63/574,933, filed on Apr. 5, 2024.
(60) Provisional application No. 63/747,969, filed on Jan. 22, 2025.

(51) Int. Cl. B60R 1/04; B60K 28/02; B60R 1/08; B60R 1/12; B60R 1/24; B60R 1/29; B60W 40/08; B60W 50/14; G06V 20/58; G06V 20/59

(52) U.S. Cl. CPC B60R 1/04; B60K 28/02; B60R 1/088; B60R 1/12; B60R 1/24; B60R 1/29; B60W 40/08; B60W 50/14; G06V 20/58; G06V 20/597; B60R 2001/1253; B60R 2300/105; B60R 2300/8006; B60R 2300/8033; B60R 2300/8093; B60W 2040/0827

(57) ABSTRACT

A vehicular driver monitoring system includes a vehicular interior rearview mirror assembly, with a mirror head that accommodates a mirror reflective element and a driver monitoring camera. The driver monitoring camera, with the mirror head adjusted to provide a rearward view for a driver of the vehicle, views at least a driver's head region of the interior cabin of the vehicle. A forward-viewing camera views a region exterior and at least forward of the vehicle and through a windshield of the vehicle. The driver monitoring camera and the forward-viewing camera transfer image data to an electronic control unit (ECU) that includes an image processor. The ECU is accommodated by the mirror head. The system, based on processing at the ECU of image data captured by the driver monitoring camera and image data captured by the forward-viewing camera, performs a driver monitoring function of the vehicle.

### CROSS REFERENCE TO RELATED APPLICATIONS

The present application claims the filing benefits of U.S. provisional application Ser. No. 63/747,969, filed Jan. 22, 2025, and U.S. provisional application Ser. No. 63/574,933, filed Apr. 5, 2024, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror head and reflective element are adjusted relative to the interior portion of a vehicle by pivotal movement about the double ball pivot configuration. The mirror head and reflective element are pivotable about either or both of the ball pivot joints by a user that is adjusting the user's rearward view.

### SUMMARY OF THE INVENTION

A vehicular driver monitoring system includes a vehicular interior rearview mirror assembly configured to attach at an interior portion of an interior cabin of a vehicle equipped with the vehicular driver monitoring system. The interior rearview mirror assembly includes a mirror head adjustable about a mounting structure. The mirror head accommodates a mirror reflective element. A driver monitoring camera is accommodated by the mirror head. The driver monitoring camera moves together and in tandem with the mirror head when, with the vehicular interior rearview mirror assembly attached at the interior portion of the interior cabin of the vehicle, the mirror head is adjusted relative to the mounting structure to set a rearward view of the driver of the vehicle. The driver monitoring camera, with the vehicular interior rearview mirror assembly attached at the interior portion of the interior cabin of the vehicle, and with the mirror head adjusted relative to the mounting structure to set the rearward view of the driver of the vehicle, views at least a driver's head region of the cabin of the vehicle. A forward-viewing camera views a region exterior and at least forward of the vehicle through a windshield of the vehicle. An electronic control unit (ECU) includes electronic circuitry and associated software. The electronic circuitry of the ECU includes an image processor for processing image data captured by the driver monitoring camera and the forward-viewing camera. The electronic circuitry of the ECU is accommodated by the mirror head. The vehicular driver monitoring system, based on processing at the ECU of image data captured by the driver monitoring camera and image data captured by the forward-viewing camera, performs a driver monitoring function of the vehicle. Further, an advanced driving assistance system (ADAS) of the vehicle may at least partially control operation of the vehicle based on processing at the ECU of image data captured by the driver monitoring camera and image data captured by the forward-viewing camera.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicular interior rearview mirror assembly;

FIGS. 2-4 are views of the interior rearview mirror assembly with a forward-viewing camera attached at the mounting structure of the mirror assembly and viewing through a windshield of the vehicle;

FIGS. 5 and 6 are views of the interior rearview mirror assembly, with the forward-viewing camera mounted remote from the mounting structure of the mirror assembly and viewing through the windshield of the vehicle;

FIG. 7 is a perspective view of the forward-viewing camera;

FIG. 8 is an exploded view of the interior rearview mirror assembly; and

FIG. 9 is a schematic view of the interior rearview mirror assembly.

### DESCRIPTION OF THE PREFERRED EMBODIMENTS

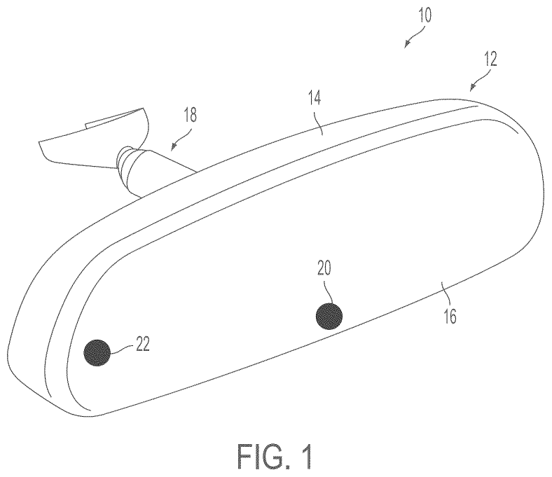

Referring now to the drawings and the illustrative embodiments depicted therein, an interior rearview mirror assembly 10 for a vehicle includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element may comprise a variable reflectance mirror reflective element, such as an electrochromic mirror reflective element, that varies its reflectance responsive to electrical current applied to conductive coatings or layers of the reflective element.

The mirror assembly 10 includes or is associated with a driver monitoring system (DMS) and/or an occupant monitoring system (OMS), or a cabin monitoring system or other system that may monitor the driver and occupants of the vehicle, optionally including passengers or occupants at one or more rear seats of the vehicle, with the mirror assembly including a driver/occupant monitoring camera 20 disposed at a back plate (and viewing through an aperture of the back plate) behind the reflective element 16 and viewing through the reflective element 16 toward at least a head region of the driver of the vehicle. By using a camera 20 having greater resolution, such as 5 megapixels or greater (e.g., the camera may include an imaging array having at least five million photosensing elements arranged in rows and columns), image data captured by the camera 20 may be processed for both the DMS and OMS function. That is, resolution of the image data captured by the camera 20 may be great enough for the DMS/OMS to monitor the driver and one or more passengers within the interior cabin of the vehicle that are viewed by the camera 20. For example, image data captured by the camera 20 may be processed for monitoring the driver, a passenger in a front seating row of the vehicle, and/or one or more passengers in a second seating row, a third seating row, or a further rearward seating row of the vehicle.

The DMS may include an infrared light (IR light) or near infrared light (near IR light) emitter 22 disposed at the back plate and emitting IR light or near IR light that passes through another aperture of the back plate and through the reflective element 16. Further, the monitoring system includes an electronic control unit (ECU) 24 having electronic circuitry and associated software, including an image processor for processing image data captured by the DMS/OMS camera (which may be a single camera that views both the driver and passenger regions or two cameras, with one camera viewing the driver region and the other camera viewing the passenger region). Image data captured by the camera may be processed for a head and face direction and position tracking system and/or eye tracking system and/or gesture recognition system. The DMS camera and monitoring system and/or head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2024-0190456; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024, and/or U.S. provisional application Ser. No. 63/641,574, filed May 2, 2024, and/or International Publication No. WO 2023/220222, which are all hereby incorporated herein by reference in their entireties.

The interior-viewing camera 20 may be disposed at the mirror head 12 of the interior rearview mirror assembly 10 and moves together and in tandem with the mirror head 12 when the driver of the vehicle adjusts the mirror head to adjust his or her rearward view. The interior-viewing camera 20 may be disposed at a lower or chin region of the mirror head below the mirror reflective element 16 of the mirror head 12, or the interior-viewing camera 20 may be disposed behind the mirror reflective element 16 and viewing through the mirror reflective element 16. Similarly, the light emitter 22 may be disposed at the lower or chin region of the mirror head 12 below the mirror reflective element 16 of the mirror head 12 (such as to one side or the other of the interior-viewing camera), or the light emitter may be disposed behind the mirror reflective element 16 and emitting light that passes through the mirror reflective element 16. The ECU 24 may be disposed at the mirror assembly 10 (such as accommodated by the mirror head). Cabin monitoring or occupant detection may be achieved via processing at the ECU 24 of image data captured by the interior-viewing camera 20. Optionally, cabin monitoring or occupant detection may be achieved in part via processing at the ECU 24 of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward-viewing or driver monitoring camera 20 and from a forward or outward-viewing camera, as well as from a rearward-viewing camera and sideward-viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0162926; US-2021-0155167; US-2018-0134217 and/or US-2014-0285666, which are all hereby incorporated herein by reference in their entireties.

The ECU 24 may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at the interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0155167 and/or US-2019-0118717, which are all hereby incorporated herein by reference in their entireties.

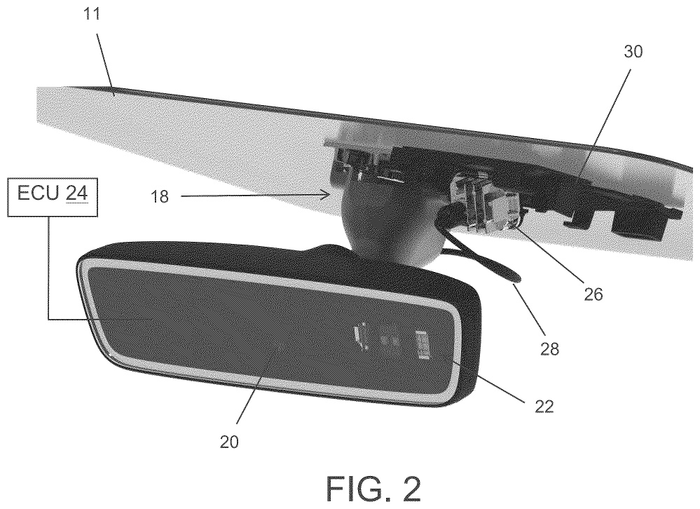

Thus, the interior rearview mirror assembly 10 accommodates the DMS/OMS camera 20 and/or near IR light emitters 22 within the mirror head 12. As shown in FIG. 2, the ECU 24 is also accommodated within the mirror head 12. That is, the electronic circuitry and associated software, such as a system on chip (SoC), for controlling operation of the DMS/OMS function is disposed within the mirror head 12.

Moreover, a forward-viewing camera 26 (FIG. 7) that views through the windshield 11 and forward of the vehicle is electrically connected to the interior rearview mirror assembly for transmitting captured image data to the ECU 24. For example, the forward-viewing camera 26 may capture image data representative of a region at least forward of the vehicle for traffic sign recognition, lane keep assist, adaptive cruise control, and/or controlling operation of other advanced driving assistance systems (ADAS) of the vehicle. The ECU 24 processes the captured image data to perform the ADAS functions. An electrical connector 28, such as a low-voltage differential signaling (LVDS) cable, extends between the mirror head 12 and the camera 26 for data transfer and/or for electrically powering the camera 26.

Optionally, image data captured by the forward-viewing camera 26 may be transferred to the ECU 24 via a coaxial cable or other suitable communication line. The coaxial cable provides bi-directional communication between the camera and the ECU. For example, the coaxial cable may provide power from the ECU to the camera and may provide control signals or data to the camera, and may receive image data from the camera. The coaxial cable and electronic connection between the ECU and the camera may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the camera to the ECU, (ii) control signals from the ECU to the camera (such as for controlling the camera), and (iii) electrical power from a DC power supply of (or connected to) the ECU to the camera.

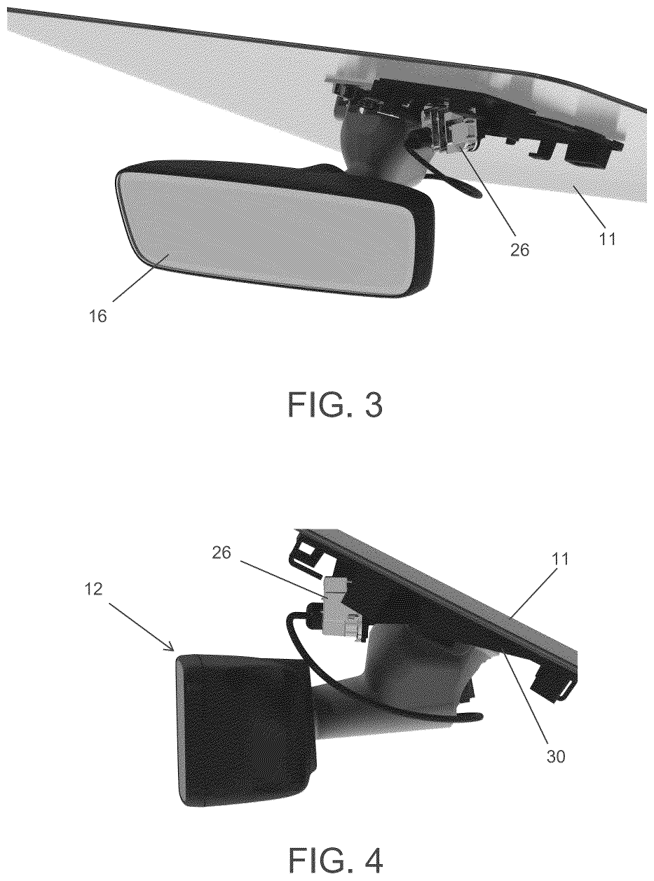

In the illustrated example of FIGS. 2-4, the forward-viewing camera 26 is attached at the mounting structure 18 of the mirror assembly 10 to view through the windshield 11 of the vehicle. For example, the mounting structure 18 may include a mounting bracket 30 attached at the in-cabin side of the windshield 11 and the camera 26 is mounted to the mounting bracket 30 and views through an aperture in the mounting bracket 30 and through the windshield 11. The mounting arm of the mounting structure 18 may be integrally formed with or attached at the mounting bracket 30.

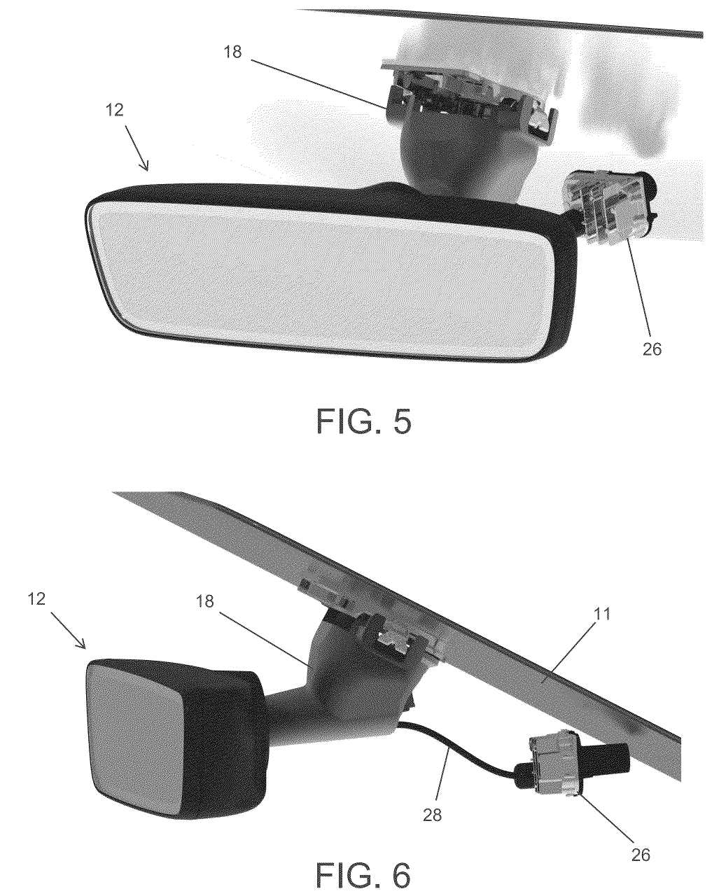

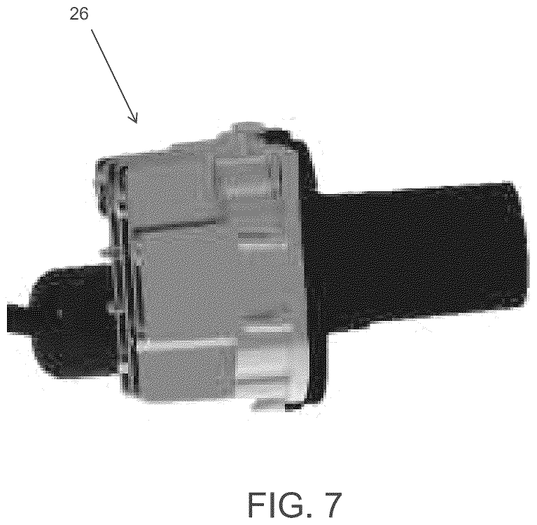

As shown in FIGS. 5 and 6, the camera 26 may attach or mount relative to the windshield 11 separate or remote from the mounting structure 18 of the mirror assembly 10. That is, the mounting structure 18 may attach to the in-cabin surface of the vehicle, such as the windshield 11 or a headliner or glass roof panel of the vehicle, and the camera 26 may attach at a structure separate from the mounting structure 18 to view through the windshield 11. The electrical connector 28 extends between the camera 26 and the along the mounting structure 18 to the mirror head 12 to transfer captured image data to the ECU 24. Optionally, the camera may be an exterior viewing camera disposed outside the cabin of the vehicle, such as a forward-viewing camera at the grille or front fascia of the vehicle, and connected via the electrical connector 28 and/or a wire harness of the vehicle to the mirror head 12.

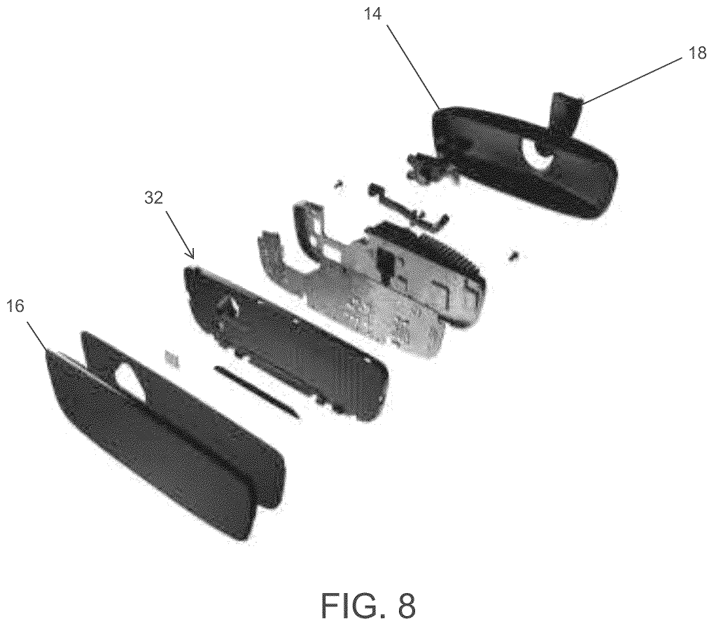

The mirror assembly may comprise an auto-dimming mirror reflective element (e.g., an electrochromic mirror reflective element) or a prismatic mirror reflective element. Both types of mirrors may include a video display screen 32 (FIG. 8) that is disposed behind and is viewable through the mirror reflective element when operated to display video images. Such video mirrors include a backlit LCD display screen, and a particular form of video mirror is a full display mirror (such as a ClearView™ Interior Rearview Mirror Assembly available from Magna Mirrors of America, Inc. of Holland, MI USA, or an FDM™ Interior Rearview Mirror Assembly available from Gentex Corporation of Zeeland, MI USA), where the video display screen fills or substantially fills the reflective region, such as by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2019-0258131; US-2019-0146297; US-2019-0118717 and/or US-2017-0355312, which are all hereby incorporated herein by reference in their entireties. When electrically operated to display images through the mirror reflective element 16, the video display screen generates heat within the mirror head 12.

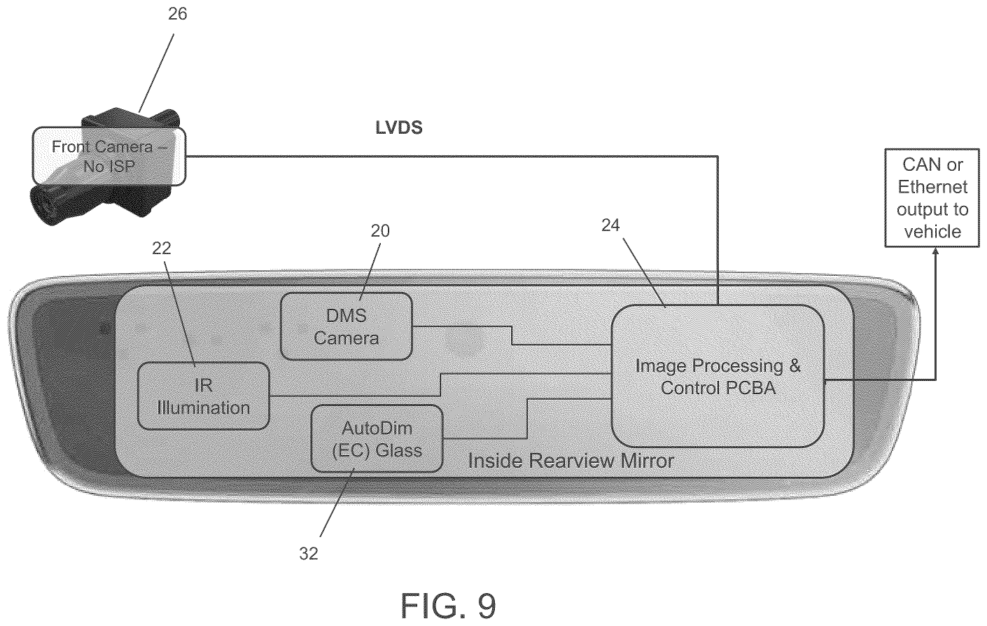

Thus, and as shown in FIG. 9, electronic circuitry of the ECU 24 at the mirror head 12 (e.g., electronic circuitry at an image processing and control printed circuit board) processes image data captured by the DMS camera 20 (or DMS/OMS camera or cabin-viewing camera) and the forward-viewing camera 26 to provide both the DMS/OMS function of the vehicle and one or more ADAS functions, such as to at least partially control operation of the vehicle as it travels along the road (e.g., to control at least one of steering, a propulsion system, a braking system, and the like). Further, the circuitry of the ECU 24 may process captured image data to generate video images for display at one or more displays of the vehicle (e.g., at the interior rearview mirror assembly, a center stack of the vehicle, and the like). The ECU 24 may process image data captured by the forward-viewing camera 26 and/or one or more additional cameras at the vehicle (e.g., a rearward-viewing camera, such as a rear backup camera or high-mounted rearward-viewing camera, one or more sideward-viewing cameras, and the like) to generate the video images for display, such as rearward video images representative of a rearward field of view provided by the mirror assembly, reverse video images displayed during a reversing maneuver of the vehicle, bird's eye view or surround view images, and the like. The ECU may output a control signal or other signal or output to another system or accessory or device of the vehicle (such as, for example, to a display device or module), such as via a communication bus of the vehicle or CAN or Ethernet communication bus or link.

Moreover, electronic circuitry at the ECU 24 may drive dimming of the electrochromic mirror reflective element 16 and/or operation of the near IR light emitters 22. For example, image data captured by the DMS camera 20 and/or the forward-viewing camera 26 (or one more other cameras at the vehicle) may be processed to determine ambient light levels within the interior cabin of the vehicle and/or exterior the vehicle. In other words, brightness levels determined by processing image data captured by the interior-viewing camera 20 and/or the forward-viewing camera 26 may be used to control dimming of the electrochromic mirror reflective element 16. This may eliminate the need for forward-sensing and/or rearward-sensing light sensors at the mirror assembly.

Optionally, the DMS/OMS camera 20 may be disposed at the mirror head and below a lower edge portion of the mirror reflective element 16. That is, the camera 20 may view the interior cabin of the vehicle and not view through the mirror reflective element. For example, the camera 20 may be disposed in a chin region that extends along the lower edge portion of the mirror head, with the camera 20 viewing through a cover element or lens element. The cover element may transmit at least a portion of visible light and/or at least a portion of infrared or near infrared light incident thereat to allow the camera to view through the cover element. Further, the cover element may reflect or block or attenuate at least a portion of visible light incident thereat to hide the camera 20 from view of the driver. Optionally, the camera may be part of a separate module that is attached to the mirror head, such as snap-attached to the lower edge portion of the mirror head, and electrically connected to circuitry at the mirror head. The camera and mirror assembly may utilize characteristics of the cameras and mirror assemblies described in U.S. provisional application Ser. No. 63/727,720, filed Dec. 4, 2024 and/or International Publication No. WO 2023/220222.

The DMS of the vehicle, via processing at the ECU 24 of image data from both the DMS camera 20 and the forward-viewing camera 26, may determine a level of distraction of the driver. For example, based on processing of image data captured by the DMS camera 20, the system may track eye positions or a gaze of the driver forward of the vehicle. Based on processing of image data captured by the forward-viewing camera 26, the system may detect objects or pedestrians or other vehicles in a region forward of the vehicle. Based on the determined gaze direction of the driver and based on the detected objects forward of the vehicle, the system may determine whether the driver is viewing the detected object or looking away from the detected object. That is, based on the determined gaze direction of the driver, the system may determine that the driver is viewing a region exterior the vehicle, and the system may determine whether the driver is viewing a detected object based on whether the viewed region exterior the vehicle corresponds to the detected object. Thus, a determination may be made as to whether the driver perceives the detected object in a path of travel of the vehicle. Accordingly, the system may adjust sensitivity of ADAS features, such as automatic emergency braking, based on the driver's attention level related to features and objects in the environment in front of the vehicle. For example, responsive to determination that the driver is viewing the detected object, the system may reduce sensitivity of ADAS features, such as to reduce a threshold distance at which emergency braking or steering control is actuated to mitigate collision with the detected object or to reduce at determined risk of collision with the object. The threshold distance between the vehicle and detected object at which emergency maneuvers are actuated may be reduced from, for example, 10 meters or less to 5 meters or less or to 3 meters or less, and the like. Responsive to determination that the driver is not viewing the detected object, the system may increase the sensitivity of ADAS features, such as to increase the threshold distance at which emergency braking or steering control is actuated to mitigate collision with the detected object or to increase the determined risk of collision with the object. The threshold distance between the vehicle and detected object at which emergency maneuvers are actuated may be increased from, for example, 3 meters or less to 5 meters or less or 10 meters or less, and the like.

Put another way, the interior rearview mirror assembly with DMS camera and connected forward-viewing camera (and optionally a forward sensing radar unit) provides a singular component to reduce costs and complexity, such as for entry/mid-level platforms. The DMS may provide regulatory required as well as enhanced DMS functionality. Further, the interior rearview mirror may have enhanced capabilities such as a video display screen operable to display rearview images. Combining the DMS and forward-viewing cameras and associated processors at the interior rearview mirror assembly frees windshield space, and may include a remote forward-viewing camera for a more compact design. The system uses one ECU for all regulatory ADAS related features. Further, the assembly may be installed in different vehicles, allowing for identical vehicle architecture across multiple platforms. That is, hardware may be installed in different vehicles with different feature content (e.g., via software) provided at different vehicles.

In some examples, at least a portion of the mirror assembly 10 and the forward-viewing camera 26 may be installed at the in-cabin surface of the vehicle windshield as a singular unit. That is, the camera 26 may be mounted or attached at the mounting structure 18 of the mirror assembly 10, such as at the mounting bracket 30, and then the mounting structure 18 may be attached to the windshield, such as adhesively attached to the windshield, to mount the mirror assembly 10 and the forward-viewing camera 26 at the windshield together and in tandem. A mounting arm of the mounting structure 18 may extend away from the mounting bracket 30 and is configured to adjustably receive the mirror head 12, such as to form a ball-and-socket joint between the mirror head and mounting arm. The mirror head 12 may be attached to the mounting arm before or after the mounting structure 18 and camera 26 are disposed at the windshield. Further, the electrical connector 28 may be connected between the mirror head 12 and the camera 26 before or after the mounting structure 18 and camera 26 are disposed at the windshield and/or the mirror head 12 is attached to the mounting arm. A housing or cover (not shown) may be disposed at the mounting bracket 30 (e.g., via snap attachment or threaded fasteners) to accommodate the camera 26, connector 28 and/or a portion of the mounting structure 18 between the cover and the mounting bracket 30.

Thus, the assembly is a sensor fusion of the DMS/OMS and forward-viewing camera with processing integrated into the interior rearview mirror assembly. The assembly includes the forward-viewing camera (without processing, not PIA to the interior mirror), the DMS/OMS camera and IR LEDs (integrated into the interior mirror), and an in-system programming (ISP) PCBA integrated into the interior rearview mirror assembly. The system is a sensor fusion of the forward-viewing camera with the mirror integrated DMS to combine processing of two or more features on a single SoC and enhances the system performance by enabling in-cabin analysis combined with exterior analysis for greater contextual awareness resulting in improved system performance.

The driver monitoring camera may include any suitable camera, such as a five megapixel RGB IR DMS camera. The forward-viewing camera may include any suitable camera, such as an eight megapixel remote front camera. The ECU may include any suitable high compute/low power SoC, such as CV2FS/CV22FS. The system may provide thermal management, such as via a heat sink disposed in the mirror assembly, to operate at temperatures of up to 85 degrees Celsius or higher. Further, the mirror assembly may provide vibration stability performance of greater than 60 Hz.

The DMS may determine head position, mouth points, and eyes closed, as well as provide a driver drowsiness and attention warning (DDAW), and an advanced driver distraction warning (ADDW). The DMS may further provide short distraction determination (e.g., basic and advanced, phone usage), long distraction determination, fatigue/unresponsive driver determination, human presence detection, front row body size, position and posture determinations, front row seat belt and proper usage determination, front row child seat detection, and driver sudden sickness determination. Further, the DMS may provide driver attention determinations, such as when smoking, phone handling, and yawning.

The image data captured by the forward camera may be used for autonomous emergency braking (AEB) in car to car, car to bicycle, and car to pedestrian determinations, as well as lane keep assist (LKA). Moreover, the image data captured by the forward-viewing camera may be processed for lane departure warning (LDW), emergency LKA, lane support system (LSS), traffic sign assist (TSA), traffic assist (TA), adaptive driving beam (ADB). Further, a front radar sensor may be integrated into the assembly, such as for general safety regulation (GSR).

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The camera bracket or mounting structure may be configured to attach to the mounting base or may attach at the in-cabin side of the vehicle windshield at or adjacent to the mounting base. Optionally, a single bracket or mounting structure may attach at the in-cabin side of the windshield and the camera and the mirror mounting base may attach (such as snap-attach or attach via one or more fasteners) at the bracket. Optionally, the mounting bracket may include a shroud or stray light shield disposed near the aperture through which the camera views. The stray light shield may reduce or limit reflections into the lens to improve visibility of the camera through the windshield. Such windshield attachment and stray light shields may utilize aspects of the cameras and windshield electronics modules described in U.S. Pat. Nos. 11,124,130; 9,896,039; 9,871,971; 9,596,387; 9,487,159; 8,256,821; 7,480,149; 6,824,281 and/or 6,690,268, which are all hereby incorporated herein by reference in their entireties.

The interior rearview mirror assembly may include circuitry therein (such as at a printed circuit board or the like disposed within the mirror casing, and electrical connection to the circuitry may be made via an electrical lead or connector of a wiring harness of the vehicle. Optionally, the electrical connector may be received through the mirror casing and through an aperture established through the toggle element, such as by utilizing aspects of the mirror assemblies described in U.S. Pat. No. 5,798,688 and/or U.S. Publication No. US-2010-0085653, which are hereby incorporated herein by reference in their entireties.

Optionally, the DMS camera may be used to detect ambient light and/or glare light (emanating from headlamps of a trailing vehicle) for use in providing auto-dimming of the EC mirror reflective element. The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Publication Nos. US-2019-0258131 and/or US-2019-0047475, and/or International Publication No. WO 2022/150826, which are all hereby incorporated herein by reference in their entireties.

The mirror assembly (such as at the mounting base, which may be fixed relative to the vehicle windshield) may include an imaging sensor (such as a forward-viewing imaging sensor or camera that has a forward field of view through the vehicle windshield) that may be part of or may provide an image output for a vehicle vision system, such as a headlamp control system or lane departure warning system or object detection system or other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281 which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular driver monitoring system, the vehicular driver monitoring system comprising:
a vehicular interior rearview mirror assembly comprises a mirror head adjustable about a mounting structure, wherein the mounting structure is configured to mount the vehicular interior rearview mirror assembly at an interior portion of an interior cabin of a vehicle;
wherein the mirror head accommodates a mirror reflective element;
a driver monitoring camera accommodated by the mirror head, wherein the driver monitoring camera moves together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
wherein, with the vehicular interior rearview mirror assembly mounted at the interior portion of the interior cabin of the vehicle, and with the mirror head adjusted about the mounting structure to provide the rearward view for the driver of the vehicle, the driver monitoring camera views at least a driver's head region of the interior cabin of the vehicle;
a forward-viewing camera, wherein the forward-viewing camera views a region exterior and at least forward of the vehicle and through a windshield of the vehicle;
an electronic control unit (ECU);
wherein image data captured by the driver monitoring camera is transferred to the ECU, and wherein image data captured by the forward-viewing camera is transferred to the ECU;
wherein the ECU comprises electronic circuitry and associated software, and
wherein the electronic circuitry of the ECU comprises an image processor operable to process image data transferred to the ECU;
wherein the electronic circuitry of the ECU is accommodated by the mirror head; and
wherein the vehicular driver monitoring system performs a driver monitoring function based at least in part on (i) processing at the ECU of image data captured by the driver monitoring camera and (ii) processing at the ECU of image data captured by the forward-viewing camera.

2. The vehicular driver monitoring system of claim 1, wherein an electrical connector extends between the forward-viewing camera and the mirror head, and wherein image data captured by the forward-viewing camera is transferred to the ECU via the electrical connector.

3. The vehicular driver monitoring system of claim 1, wherein, with the vehicular interior rearview mirror assembly mounted at the interior portion of the interior cabin of the vehicle, the forward-viewing camera is mounted at the mounting structure of the vehicular interior rearview mirror assembly to view through the windshield of the vehicle.

4. The vehicular driver monitoring system of claim 3, wherein the mounting structure of the vehicular interior rearview mirror assembly comprises a light shield, and wherein the forward-viewing camera is mounted at the light shield of the mounting structure.

5. The vehicular driver monitoring system of claim 1, wherein, with the vehicular interior rearview mirror assembly mounted at the interior portion of the interior cabin of the vehicle, the forward-viewing camera is mounted remote from the mounting structure of the vehicular interior rearview mirror assembly to view through the windshield of the vehicle.

6. The vehicular driver monitoring system of claim 1, wherein an advanced driving assistance system (ADAS) of the vehicle at least partially controls operation of the vehicle based at least in part on (i) processing at the ECU of image data captured by the driver monitoring camera and (ii) processing at the ECU of image data captured by the forward-viewing camera.

7. The vehicular driver monitoring system of claim 1, wherein an occupant monitoring function is based at least in part on processing at the ECU of image data captured by the driver monitoring camera.

8. The vehicular driver monitoring system of claim 1, wherein the driver monitoring camera comprises an imaging array having at least five million photosensing elements arranged in rows and columns.

9. The vehicular driver monitoring system of claim 1, wherein the mirror reflective element comprises an electrochromic mirror reflective element, and wherein dimming of the electrochromic mirror reflective element is controlled based at least in part on (i) processing at the ECU of image data captured by the driver monitoring camera and (ii) processing at the ECU of image data captured by the forward-viewing camera.

10. The vehicular driver monitoring system of claim 9, wherein the ECU includes electronic circuitry for controlling dimming of the electrochromic mirror reflective element.

11. The vehicular driver monitoring system of claim 1, wherein the driver monitoring camera is disposed at a chin module that is attached at a lower region of the mirror head.

12. The vehicular driver monitoring system of claim 1, wherein the mirror head accommodates a video display screen, and wherein, with the vehicular interior rearview mirror assembly mounted at the interior portion of the interior cabin of the vehicle, the video display screen is electrically operable to display video images for viewing by the driver.

13. The vehicular driver monitoring system of claim 12, wherein the ECU includes electronic circuitry for generating the video images displayed at the video display screen for viewing by the driver.

14. The vehicular driver monitoring system of claim 1, wherein the driver monitoring function comprises at least one selected from the group consisting of (i) determining a gaze direction of the driver of the vehicle, (ii) determining that the driver of the vehicle is attentive, (iii) determining that the driver of the vehicle is distracted and (iv) determining that the driver of the vehicle is drowsy.

15. The vehicular driver monitoring system of claim 1, wherein the vehicular driver monitoring system detects an object present at a portion of the region exterior and at least forward of the vehicle based at least in part on processing at the ECU of image data captured by the forward-viewing camera, and wherein the vehicular driver monitoring system determines whether the driver is viewing the portion of the region exterior and at least forward of the vehicle based at least in part on processing at the ECU of image data captured by the driver monitoring camera.

16. The vehicular driver monitoring system of claim 15, wherein, responsive to determination that the driver is viewing the portion of the region exterior and at least forward of the vehicle, the vehicular driver monitoring system determines that the driver of the vehicle is attentive.

17. The vehicular driver monitoring system of claim 16, wherein the vehicular driver monitoring system does not alert the attentive driver of presence of the detected object.

18. The vehicular driver monitoring system of claim 15, wherein, responsive to determination that the driver is not viewing the portion of the region exterior and at least forward of the vehicle, the vehicular driver monitoring system determines that the driver of the vehicle is distracted.

19. The vehicular driver monitoring system of claim 18, wherein the vehicular driver monitoring system alerts the distracted driver of presence of the detected object.

20. A vehicular driver monitoring system, the vehicular driver monitoring system comprising:
a vehicular interior rearview mirror assembly comprises a mirror head adjustable about a mounting structure, wherein the mounting structure is configured to mount the vehicular interior rearview mirror assembly at an interior portion of an interior cabin of a vehicle;
wherein the mirror head accommodates a mirror reflective element;
a driver monitoring camera accommodated by the mirror head, wherein the driver monitoring camera moves together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
wherein, with the vehicular interior rearview mirror assembly mounted at the interior portion of the interior cabin of the vehicle, and with the mirror head adjusted about the mounting structure to provide the rearward view for the driver of the vehicle, the driver monitoring camera views at least a driver's head region of the interior cabin of the vehicle;
a forward-viewing camera, wherein the forward-viewing camera views a region exterior and at least forward of the vehicle and through a windshield of the vehicle;
wherein, with the vehicular interior rearview mirror assembly mounted at the interior portion of the interior cabin of the vehicle, the forward-viewing camera is mounted at the mounting structure of the vehicular interior rearview mirror assembly to view through the windshield of the vehicle;
an electronic control unit (ECU);
wherein image data captured by the driver monitoring camera is transferred to the ECU, and wherein image data captured by the forward-viewing camera is transferred to the ECU;
wherein the ECU comprises electronic circuitry and associated software, and wherein the electronic circuitry of the ECU comprises an image processor operable to process image data transferred to the ECU;
wherein the electronic circuitry of the ECU is accommodated by the mirror head;
wherein an electrical connector extends between the forward-viewing camera and the mirror head, and wherein image data captured by the forward-viewing camera is transferred to the ECU via the electrical connector; and
wherein the vehicular driver monitoring system performs a driver monitoring function based at least in part on (i) processing at the ECU of image data captured by the driver monitoring camera and (ii) processing at the ECU of image data captured by the forward-viewing camera.

21. The vehicular driver monitoring system of claim 20, wherein an advanced driving assistance system (ADAS) of the vehicle at least partially controls operation of the vehicle based at least in part on (i) processing at the ECU of image data captured by the driver monitoring camera and (ii) processing at the ECU of image data captured by the forward-viewing camera.

22. The vehicular driver monitoring system of claim 20, wherein the mirror reflective element comprises an electrochromic mirror reflective element, and wherein dimming of the electrochromic mirror reflective element is controlled based at least in part on (i) processing at the ECU of image data captured by the driver monitoring camera and (ii) processing at the ECU of image data captured by the forward-viewing camera.

23. The vehicular driver monitoring system of claim 20, wherein the driver monitoring function comprises at least one selected from the group consisting of (i) determining a gaze direction of the driver of the vehicle, (ii) determining that the driver of the vehicle is attentive, (iii) determining that the driver of the vehicle is distracted and (iv) determining that the driver of the vehicle is drowsy.

24. The vehicular driver monitoring system of claim 20, wherein the vehicular driver monitoring system detects an object present at a portion of the region exterior and at least forward of the vehicle based at least in part on processing at the ECU of image data captured by the forward-viewing camera, and wherein the vehicular driver monitoring system determines whether the driver is viewing the portion of the region exterior and at least forward of the vehicle based at least in part on processing at the ECU of image data captured by the driver monitoring camera, and wherein, responsive to determination that the driver is viewing the portion of the region exterior and at least forward of the vehicle, the vehicular driver monitoring system determines that the driver of the vehicle is attentive, and wherein, responsive to determination that the driver is not viewing the portion of the region exterior and at least forward of the vehicle, the vehicular driver monitoring system determines that the driver of the vehicle is distracted.

25. A vehicular driver monitoring system, the vehicular driver monitoring system comprising:
a vehicular interior rearview mirror assembly comprises a mirror head adjustable about a mounting structure, wherein the mounting structure is configured to mount the vehicular interior rearview mirror assembly at an interior portion of an interior cabin of a vehicle;
wherein the mirror head accommodates a mirror reflective element;
a driver monitoring camera accommodated by the mirror head, wherein the driver monitoring camera moves together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
wherein, with the vehicular interior rearview mirror assembly mounted at the interior portion of the interior cabin of the vehicle, and with the mirror head adjusted about the mounting structure to provide the rearward view for the driver of the vehicle, the driver monitoring camera views at least a driver's head region of the interior cabin of the vehicle;
wherein the driver monitoring camera comprises an imaging array having at least five million photosensing elements arranged in rows and columns;
a forward-viewing camera, wherein the forward-viewing camera views a region exterior and at least forward of the vehicle and through a windshield of the vehicle;
wherein, with the vehicular interior rearview mirror assembly mounted at the interior portion of the interior cabin of the vehicle, the forward-viewing camera is mounted remote from the mounting structure of the vehicular interior rearview mirror assembly to view through the windshield of the vehicle;
an electronic control unit (ECU);
wherein image data captured by the driver monitoring camera is transferred to the ECU, and wherein image data captured by the forward-viewing camera is transferred to the ECU;
wherein the ECU comprises electronic circuitry and associated software, and wherein the electronic circuitry of the ECU comprises an image processor operable to process image data transferred to the ECU;
wherein the electronic circuitry of the ECU is accommodated by the mirror head;
wherein an occupant monitoring function is based at least in part on processing at the ECU of image data captured by the driver monitoring camera; and
wherein the vehicular driver monitoring system performs a driver monitoring function based at least in part on (i) processing at the ECU of image data captured by the driver monitoring camera and (ii) processing at the ECU of image data captured by the forward-viewing camera.

26. The vehicular driver monitoring system of claim 25, wherein an advanced driving assistance system (ADAS) of the vehicle at least partially controls operation of the vehicle based at least in part on (i) processing at the ECU of image data captured by the driver monitoring camera and (ii) processing at the ECU of image data captured by the forward-viewing camera.

27. The vehicular driver monitoring system of claim 25, wherein the mirror reflective element comprises an electrochromic mirror reflective element, and wherein dimming of the electrochromic mirror reflective element is controlled based at least in part on (i) processing at the ECU of image data captured by the driver monitoring camera and (ii) processing at the ECU of image data captured by the forward-viewing camera.

28. The vehicular driver monitoring system of claim 25, wherein the driver monitoring function comprises at least one selected from the group consisting of (i) determining a gaze direction of the driver of the vehicle, (ii) determining that the driver of the vehicle is attentive, (iii) determining that the driver of the vehicle is distracted and (iv) determining that the driver of the vehicle is drowsy.

29. The vehicular driver monitoring system of claim 25, wherein the vehicular driver monitoring system detects an object present at a portion of the region exterior and at least forward of the vehicle based at least in part on processing at the ECU of image data captured by the forward-viewing camera, and wherein the vehicular driver monitoring system determines whether the driver is viewing the portion of the region exterior and at least forward of the vehicle based at least in part on processing at the ECU of image data captured by the driver monitoring camera, and wherein, responsive to determination that the driver is viewing the portion of the region exterior and at least forward of the vehicle, the vehicular driver monitoring system determines that the driver of the vehicle is attentive, and wherein, responsive to determination that the driver is not viewing the portion of the region exterior and at least forward of the vehicle, the vehicular driver monitoring system determines that the driver of the vehicle is distracted.
